(19) United States
(12) Patent Application Publication
(10) Pub. No.: US 2015/0284611 A1
(43) Pub. Date: Oct. 8, 2015

(54) DAMP COURSE-FORMING COMPOSITION AND USE THEREOF

(71) Applicant: HILTI AKTIENGESELLSCHAFT, Schaan (LI)

(72) Inventors: Frank Thiemann, Landsberg/Lech (DE); Juliane Marauska, Itzehoe (DE)

(21) Appl. No.: 14/740,460

(22) Filed: Jun. 16, 2015

Related U.S. Application Data
(63) Continuation of application No. PCT/EP2013/076866, filed on Dec. 17, 2013.

(30) Foreign Application Priority Data
Dec. 21, 2012 (DE) 10 2012 224 300.3

(51) Int. Cl. C09J 183/04; C09J 171/00; C09J 133/08; C09D 7/12; C09D 5/18; C09D 183/04; C09D 171/00; C09D 133/08; C09J 9/00; C09J 11/04

(52) U.S. Cl. CPC C09J 183/04; C09J 9/00; C09J 171/00; C09J 133/08; C09J 11/04; C09D 5/18; C09D 183/04; C09D 171/00; C09D 133/08; C09D 7/1216

(57) ABSTRACT

A composition forming an insulating layer is described, whereby a binder based on an alkoxysilane-functionalized polymer carries the alkoxy-functionalized silane group, containing water and an insulation layer-forming additive. The composition according to the invention results in a relatively high expansion rate, enabling coatings to be applied to achieve the layer thickness required for the respective fire resistance duration in a simple and rapid manner, whereby the layer thickness is reduced to a minimum but offers significant insulating effect. The composition according to the invention is particularly suitable for fire protection, especially for the coating of steel components, such as columns, beams, frame members, in order to increase the fire resistance duration.

### RELATED APPLICATIONS

This application claims priority to, and is a continuation of, PCT Application No. PCT/EP2013/076866 having an International filing date of Dec. 17, 2013, which is incorporated herein by reference, and which claims priority to German Patent Application No. 10 2012 224 300.3, having a filing date of Dec. 21, 2012, which is also incorporated herein by reference] in its entirety.

### SUMMARY OF THE TECHNOLOGY

The present invention relates to an intumescent composition, particularly a two or multi-component composition having intumescent properties and carrying a binder based on an alkoxysilane-functionalized polymer which has alkoxy-functionalized silane, and its use for fire protection, especially for coatings of components, such as columns, beams, or frame members in order to increase fire resistance duration.

### BACKGROUND OF THE INVENTION

Intumescent compositions, also known as insulating compositions, are usually applied to form coatings on the surface of components to protect them from fire or intense heat exposure resulting from fire. Steel structures are now an integral part of modem architecture, even if they suffer from a crucial disadvantage compared to reinforced concrete. Above about 500° C., the load-carrying capacity of the steel is reduced by 50%, i.e. the steel loses its stability and load-carrying capacity. This temperature can vary depending on the fire load, for example in the case of direct fire exposure, approximately 1000° C. can be reached after about 5-10 minutes, which often leads to a loss of viability of the structure. The objective of fire protection, in particular for the fire protection of steel, is, in the event of fire, to delay as long as possible the loss of the steel structure viability in order to save human lives and valuable assets.

In the building regulations of many countries, appropriate fire resistance durations are required for certain steel structures. They are defined as so-called F-class, such as F 30, F 60, F 90 (fire resistance classes according to DIN 4102-2) or American classes according to ASTM etc. According to DIN 4102-2, for example, F 30 means that, in the event of fire under normal conditions, a supporting steel structure must withstand the fire for at least 30 minutes. This is usually achieved by delaying the heating rate of the steel, for example, by coating the steel structure with intumescent coatings. These includes coatings whose components form a solid microporous carbon foam in the event of fire. In this case, this forms a fine-pored and thick foam layer, the so-called ash crust, which, depending on the composition, is highly thermally insulating, and thus the heating of the component is delayed, so that the critical temperature of about 500° C. is reached at the earliest after 30, 60, 90, 120 minutes or up to 240 minutes. The thickness of the applied coating layer, or the ash crust developing therefrom, is crucial to attaining the required fire resistance duration. Closed profiles, such as pipes with comparable solidity, require about twice the amount compared to open profiles, such as beams with a double-T profile. In order for the required fire resistance times to be achieved, the coating must have a certain thickness and have the ability to form as voluminous, and thus good insulating, ash crust as possible when exposed to heat and which remains mechanically stable over the period of exposure to fire.

Various systems are proposed in the prior art for this purpose. Essentially, one distinguishes between 100% systems and solvent or water-based systems. In the case of the solvent or water-based systems, a binder, usually a resin, is applied as a solution, dispersion or emulsion on the component. These may be designed as single or multi-component systems. After application, the solvent or water evaporates and leaves behind a film that dries over time. In this case, one may further distinguish between systems where there are essentially no longer changes during the drying of the coating, and systems, where, after evaporation, the binder is primarily cured by oxidation and polymerization reactions which are induced, for example, by atmospheric oxygen. The 100% systems contain the components of the binder without solvents or water. They are applied to the component, and the “drying” of the coating takes place only by the reaction of the binder components to one another.

The solvent or water based systems have the disadvantage that the drying times, also referred to as curing, are long, while more layers also have to be applied thus requiring several operations in order to achieve the required layer thickness. Since each layer must be dried appropriately before applying the next layer, this leads first of all to a high expenditure of labor and correspondingly high costs and a delay in the completion of the building, because the repeated applications to achieve the required thickness depend on the climatic conditions and, in some cases, can take several days. Another disadvantage is that the coating may gravitate during drying or exposure to heat, resulting in cracking and flaking of the required layer thickness, whereby the surface may be partially exposed in a worst case scenario, particularly in systems where the binder is not cured by evaporation of the solvent or water.

To overcome this disadvantage, two or multi-component systems based on an epoxy-amine-base have been developed that require almost no solvent, so that curing is much faster and thicker layers may also be applied in one step, so that the required layer thickness is formed much faster. However, these have the disadvantage that the binder is a very stable and rigid polymer matrix with an often high softening range, which hinders the formation of foam by the foaming agent. Thus, thick layers must be applied in order to generate sufficient foam thickness for insulation. This is in turn disadvantageous in that a great deal of material is required. In order to implement these systems, processing temperatures of up to +70° C. are often required, which makes the use of these systems laborious and expensive to implement. In addition, some of the binder components used are toxic or otherwise critical (e.g. irritant, corrosive), such as in the case of amines or amine mixtures used in the epoxy-amine systems.

WO 2010/131037 A1 discloses a composition, which is based on silane-terminated polyurethanes or silane-terminated polyethers as the binder, with compatible plasticizers and intumescent additives. This composition is cured by humidity. Accordingly, the curing of the composition begins at the surface. However, this is disadvantageous in that the curing is highly dependent on the humidity and on the layer thickness, which generally leads to long curing times or, in very dry conditions, to no curing at all. Another disadvantage is that curing is highly inhomogeneous while the crosslinking density may also vary greatly.

### BRIEF SUMMARY OF THE INVENTION

The invention is therefore based on the task of providing an insulation-forming coating system of the aforementioned type, which avoids the above-mentioned disadvantages, and which, in particular, is not solvent or water-based, and offers fast, uniform curing and requires only a small layer thickness due to the high intumescence, i.e. the formation of an effective ash crust layer.

This task is solved by the addition of water. In particular, the task is solved by the composition according to claim 1. Preferred embodiments are disclosed in the dependent claims.

The invention is, therefore, an intumescent composition comprising a component A, which contains an alkoxysilane polymer, which terminates and/or contains pendant groups along the polymer chain of alkoxy silane groups of the general formula (I)

—Si(R1)m(OR2)3−m (I)

whereby R¹ contains a linear or branched C₁-C₁₆-alkyl radical, preferably a methyl or ethyl radical, R² is a linear or branched C₁-C₆ alkyl radical and m is an integer from 0 to 2, with a component B, the water, and with a component C containing an insulation-forming additive.

According to the invention, a polymer is a molecule with six or more repeat units, which may have a structure that is linear, branched, star-shaped, wound, hyper-branched or may be crosslinked. Polymers may have a single type of repeat unit (“homopolymers”) or they may have more than one type of repeat unit (“copolymers”). As used herein, the term “polymer” includes both prepolymers, which may also include oligomers with 2-5 repeat units, such as are used as component A alkoxysilane compounds which react with each other in the presence of water to form Si—O—Si bonds, as well as polymeric compounds formed by the above-mentioned reaction.

Thus, the components A and B are not prematurely brought into contact with each other and the curing initiated prematurely, and so the component A and the component B are advantageously separated from one another in order to inhibit any reaction.

By means of the composition according to the invention, coatings may be applied to achieve the layer thickness required for the respective fire resistance duration in a simple and rapid manner. The advantages achieved by the invention are essentially to be seen in that, in comparison with the solvent or water-based systems with their inherent slow curing, but also in comparison with a composition according to WO 2010/131037 A1, the working time may be reduced considerably and no solvent is used. It is advantageous, especially with respect to a composition according to the WO 2010/131037 A1, that the curing of a composition according to the invention is independent of the humidity of the environment in which the composition is applied.

A further advantage is that hazardous substances and those subject to labeling, such as critical amine compounds, may be largely or completely dispensed with.

Due to the lower platicizing range of the polymer matrix compared with epoxy-amine base systems, the intumescence is relatively high with respect to the rate of expansion, so that a high insulating effect is achieved even with thin layers. The possible composition with fire protection additives also contributes to the high degree of filling. Accordingly, the cost of materials falls, which has a particularly favorable effect on the cost of materials in large-scale applications. This is achieved, in particular, through the use of a reactive system that is not physically dried, but chemically cured by hydrolysis and subsequent polycondensation. Thus, only a small volume loss is registered by the drying of solvents or of water in the case of water-based systems. Thus, in a conventional system, a solvent content of about 25% is typical. This means that in the case of a 10 mm layer, there remain only 7.5 mm as the actual protective layer on the substrate to be protected. In the composition according to the invention, more than 93% of the coating remains on the substrate to be protected.

Compared with solvent or water based systems when they are applied without a primer, the compositions according to the invention show excellent adhesion to various metallic and non-metallic substrates, as well as excellent cohesion and impact resistance.

### BRIEF DESCRIPTION OF SEVERAL VIEWS OF THE DRAWINGS

[Not Applicable]

### DETAILED DESCRIPTION OF THE INVENTION

In order to better understand the invention, the following explanations of the terminology used herein are believed to be useful. For the purposes of the invention:
“chemical intumescence” means the formation of a voluminous, insulating layer of ash crust through coordinated compounds which react with one another when exposed to heat;
“physical intumescence” means the formation of a voluminous, insulating layer by the swelling of a compound without a chemical reaction taking place between two compounds, and that gives off gases when exposed to heat, whereby the volume of the compound increases to a multiple of the original volume;
“insulating layer forming” means that, in event of fire, a solid microporous carbon foam is produced, so that the fine pore and thick foam layer so formed, the so-called ash crust, insulates a substrate against heat depending on the composition;
“Carbon source’ is an organic compound which leaves behind a carbon network by incomplete combustion and does not fully burn to produce carbon dioxide and water (carbonification); these compounds are also referred to as “carbon network formers”;
“acidifier” means a compound that under the effect of heat above about 150° C., for example forms a non-volatile acid through decomposition, and thus acts as a catalyst for the carbonification; moreover, it can contribute to lowering the viscosity of the melt of the binder; and thus the term “dehydrogenation catalyst” is used synonymously;
“blowing agent” is a compound that decomposes at an elevated temperature into inert, i.e. non-flammable gases, and, where appropriate, inflates the softening binder to form a foam (intumescence); this term is used synonymously with “gas formers”;
“ash crust stabilizer” is a so-called network-forming compound which stabilizes the carbon network (ash crust) formed by the interaction of the carbon formation from the carbon source and the gas from the blowing agent or physical intumescence. The principle of operation is that they, in themselves, very soft resulting carbon layers are mechanically bonded by inorganic compounds. The addition of such an ash crust stabilizer contributes to a significant stabilization of the intumescent crust in the event of fire, as these additives increase the mechanical strength of the intumescent layer and/or prevent their dripping off.

According to the invention, the alkoxysilane-functional polymer comprises a backbone selected from the group consisting of a polyether, polyester, polyetherester, polyamide, polyurethane, polyester urethane, polyether urethane, polyether/ester urethane, polyamide urethane, polyurea, polyamine, polycarbonate, polyvinyl, polyacrylate, polyolefin such as polyethylene or polypropylene, polyisobutylene, polysulfide, rubber, neoprene, phenol resin, epoxy resin, melamine. The backbone may be linear or branched (linear backbone with side chains along the chain of the backbone) and includes terminating alkoxysilane groups, preferably at least two alkoxysilane groups, i.e. as end groups of a linear backbone, or as end groups of the linear backbone and end groups of the side groups.

The alkoxy silane has the general formula (I)

—Si(R1)m(OR2)3−m (I),

whereby R¹ is a linear or branched C₁-C₁₆-alkyl radical, preferably a methyl or ethyl radical, R² is a linear or branched C₁-C₆-alkyl radical, preferably a methyl or ethyl radical, and m is an integer from 0 to 2 preferably 0 or 1. Most preferably, the at least two alkoxy silane groups are difunctional (m=1) or trifunctional (m=0) and the alkoxy group is a methoxy or ethoxy group.

Preferably, the alkoxysilane group, bound to the backbone, may itself act either as an electron donor or an atom via a group such as an additional further functional group (for example, X=—S—, —OR, —NHR, —NR₂), whereby the two functional groups, i.e. the further functional group and the alkoxysilane group are connected to one another via a methylene bridge (—X—CH₂—Si(R¹)ₘ(OR²)₃₋ₘ). In this way, an electron interaction (back-bonding) between the silicon atom and the electron donor is caused, whereby electron density is moved from the donor to the silicon atom, which leads to a weakening of the Si—O bond, which in turn results in a greatly increased reactivity of the Si-alkoxy groups. This is the so-called a effect. Such compounds are also referred to as a silanes.

Most preferred is when the alkoxysilane polymers are polymers in which the backbone is terminated with a silane group via a urethane, such as dimethoxy-(methyl)silylmethylcarbamate-terminated polyether, diethoxy(methyl)silylmethyl-carbamate-terminated polyethers, tri methoxysilylmethylcarbamate-terminated polyethers, triethoxysilylmethylcarbamate-terminated polyether or mixtures thereof.

Examples of suitable polymers include silane-terminated polyether (e.g. Geniosil® STP-E 10 and Geniosil® STP-E 30 from Wacker Chemie AG) and silane-terminated polyurethanes (e.g. polymer ST61, polymer ST75 and polymer ST77 from Evonik Hanse, Desmoseal® S XP 2458, Desmoseal® S XP 2636, Desmoseal® S XP 2749, Desmoseal® S XP 2821 from Bayer, SPUR+*1050 mm, SPUR+1015LM, SPUR+*3100HM, SPUR+*3200HM from Momentive).

Usually, these alkoxysilane-functional polymers have a content of the alkoxy groups of 0.20 to 1.0 mmol/g, preferably 0.2 to 0.85 mmol/g, more preferably 0.25 to 0.80 mmol/g, still more preferably from 0.25 to 0.70 mmol/g, even more preferably 0.30 to 0.70 mmol/g, even more preferably 0.35 to 0.70 mmol/g and exceptionally more preferably 0.40 to 0.60 mmol/g.

As alternative polymers, preferably those are used where the alkoxysilane groups are incorporated non-terminally into the backbone of the polymer, but are specifically laterally distributed over the chain of the backbone. Important properties such as crosslinking density can be controlled through the incorporated multiple crosslinking units. As a suitable example of this, may be mentioned the TEGOPAC® product line from Evonik Goldschmidt GmbH such as TEGOPAC BOND 150, TEGOPAC BOND 250 and TEGOPAC SEAL 100. In this context, for example, reference is made to DE 102008000360 A1, DE 102009028640 A1, DE102010038768 A1 and DE 102010038774 A1.

Usually these alkoxysilane polymers have the polymer 2 to 8 alkoxy silane groups per prepolymer molecule.

The degree of crosslinking of the binder and thus both the strength of the resulting coating as well as its elastic properties can be adjusted as a function of the alkoxysilane group functionality of the polymer.

Usually the amount of the binder is 5 to 50 wt.-%, preferably 5 to 40 wt.-%, more preferably 6 to 35 wt.-% and still more preferably 10 to 30 wt. %, with respect to the composition.

According to the invention, the composition contains water as a further component B. The water acts primarily as a crosslinking agent or as a reactant. This results in more homogeneous and faster curing of the binder, compared with a composition according to WO 2010/131037 A1. The curing of the composition is therefore largely independent of the absolute humidity, and the composition cures reliably and quickly even under extremely dry conditions.

According to the invention, the water content in the composition is up to 5 wt.-% with respect to the polymer amount, whereby the content lies in the range preferably between 0.1 and 5 wt.-%, more preferably between 0.5 and 3 wt.-%, and even more preferably between 0.6 to 2 wt.-%.

According to the invention, the component C contains one insulation-forming additive, whereby the additive may include both single compounds as well as a mixture of several compounds.

Useful intumescent additives include those which, by forming an inflated insulating layer of flame-resistant material under the effect of heat, protects the substrate from overheating and thereby prevents or at least delays changes in the mechanical and static properties of the structural elements due to heat. The formation of a voluminous insulating layer, namely a layer of ash crust, may be effected by the chemical reaction of a mixture of appropriately coordinated compounds which react with one another when exposed to heat. Such systems are known to the person skilled in the art under the term chemical intumescence and can be used according to the invention. Alternatively, the voluminous insulating layer may be formed by physical intumescence. In each case, both systems may be used either alone or together in combination according to the invention.

At least three components are generally required for the formation of an intumescent layer by chemical intumescence, i.e. a carbon source, a dehydrogenation catalyst and a blowing agent that are contained, for example, in coatings in a binder. On heating, the binder softens and the fire-protection additives are released so that they react with one another in the event of chemical intumescence or can swell in the case of physical intumescence. Acid is formed from the dehydrogenation catalyst through thermal decomposition, and serves as a catalyst for carbonification of the carbon sources. At the same time, the blowing agent decomposes to form thermally inert gases causing a swelling of the carbonized (burned) material and optionally the plasticized binder to form a voluminous insulating foam.

In one embodiment of the invention, in which the insulating layer is formed by chemical intumescence, the intumescent additive comprises at least one carbon network former insofar as the binder cannot be used as such, at least one acidifier, at least one blowing agent and at least one inorganic matrix former. The components of the additive are specially selected so that they develop a synergy, whereby some of the compounds may have several functions.

The compounds commonly used as a carbon source in intumescent flame retardants and known to persons skilled in the art, such as starch-like compounds, e.g. starch and modified starch, and/or polyhydric alcohols (polyols), such as saccharides and polysaccharides and/or a thermoplastic or thermoset polymeric resin binder such as a phenolic resin, a urea resin, a polyurethane, polyvinyl chloride, poly(methyl)acrylate, polyvinyl acetate, polyvinyl alcohol, a silicone resin and/or a rubber. Suitable polyols are polyols selected from the group including sugar, pentaerythritol, dipentaerythritol, tripentaerythritol, polyvinyl acetate, polyvinyl alcohol, sorbitol, EO-PO polyols. Pentaerythritol, dipentaerythritol, or polyvinyl acetate are preferably used.

It should be noted that, in event of fire, the binder itself can also have the function of a carbon source.

The compounds commonly used as dehydrogenation catalysts or acid generators in intumescent fire protection formulations and known to those skilled in the art, such as a salt or an ester of an inorganic, non-volatile acid selected from among sulfuric acid, phosphoric acid or boric acid. Essentially, phosphorus-containing compounds are used and the pallet is very large, since they extend over a plurality of oxidation states of phosphorus, such as phosphines, phosphine oxides, phosphonium compounds, phosphates, elemental red phosphorus, phosphites and phosphates. As for phosphoric acid compounds, by way of example may be mentioned: mono-ammonium phosphate, diammonium phosphate, ammonium phosphate, ammonium polyphosphate, melamine phosphate, melamine phosphate, potassium phosphate, polyol phosphates such as pentaerythritol phosphate, glycerol phosphate, sorbitol phosphate, mannitol phosphate, dulcet phosphate, neopene tylglycol phosphate, ethylene glycol phosphate, di-pentaerythritol phosphate and the like. A polyphosphate or ammonium polyphosphate is preferably used as a phosphoric acid compound. Compounds such as reaction products of Lamelite C (melamine formaldehyde resin) with phosphoric acid are to be understood among melamine resin phosphates. As sulfuric acid compounds, may be mentioned as examples: ammonium sulfate, ammonium sulfamate, nitroaniline bisulfate, 4-nitroaniline-2-sulfonic and 4,4 dinitro sulfanilamide and the like. Melamine borate may be mentioned as an example of a boric acid compound.

Suitable blowing agents are the compounds commonly used in flame retardants and known to persons skilled in the art, such as cyanuric acid or isocyanic acid and derivatives thereof, melamine and derivatives thereof. Such blowing agents include cyanamide, dicyanamide, dicyandiamide, guanidine and its salts, biguanide, melamine cyanurate, cyanic acid salts, cyanic acid esters and amides, hexamethoxymethylmelamine, dimelamine pyrophosphate, melamine polyphosphate, melamine phosphate. Preferably hexamethoxymethylmelamine or melamine (cyanuric acid amide) is used.

Also suitable are components whose action is not limited to a single function, such as melamine, which acts both as an acidifier as well as a blowing agent. Further examples are described in GB 2 007 689 A1, EP 139 401 A1 and U.S. Pat. No. 3,969,291 A1.

In one embodiment of the invention, in which the insulating layer is formed by physical intumescence, the intumescent additive comprises at least one thermo-expandable compound as a graphite intercalation compound, which is also known as expandable graphite. This may also be, in particular, homogeneously contained in the binder.

As expandable graphite intercalation, there are known compounds such as SOₓ, NOₓ, halogen and/or strong acids in graphite. These are also referred to as graphite salts. Preferred expandable graphites which release S0₂, S0₃, NO and/or N0₂ at temperatures of, for example 120 to 350° C. on swelling. The expandable graphite may be, for example, in the form of flakes having a maximum diameter in the range of 0.1 to 5 mm. Preferably this diameter lies in the range 0.5 to 3 mm. Suitable expandable graphites are commercially available for the present inventio. Generally, the particles of expandable graphite are uniformly distributed in the fire protection elements according to the invention. However, the concentration of expandable graphite may also be selectively varied pattern-like, flat and/or sandwiched. In this respect, reference is made to EP 1489136 A1, which is incorporated herein by reference.

In a further embodiment of the invention, the insulating layer is formed through both chemical as well as physical intumescence, so that the intumescent additive includes both a carbon source, a dehydrogenation catalyst and a blowing agent as well as thermally expandable compounds.

Since the ash crust formed in the event of fire is usually too unstable and, depending on its density and structure, may be blown around by air currents and adversely affect the insulating effect of the coating, at least one ash crust stabilizer is preferably added to the above-mentioned components.

Compounds commonly used in fire protection formulations as an ash crust stabilizer or matrix former and known to persons skilled in the art, include expandable graphite and particulate metals such as aluminum, magnesium, iron and zinc. The particulate metal may be in the form of a powder, platelets, scales, fibers, threads and/or whiskers, whereby the particulate metal in the form of powder, flakes or scales has a particle size of ≦50 μm, preferably from 0.5 to 10 μm. When using the particulate metal in the form of fibers, filaments and/or whiskers, a thickness of 0.5 to 10 μm and a length of 10 to 50 μm is preferred. Alternatively or additionally an oxide or a compound of a metal from the aluminum, magnesium, iron or zinc group may be used as an ash crust stabilizer, in particular iron oxide, preferably ferric oxide, titanium dioxide, a borate, such as zinc borate and/or a glass frit made of low-melting glasses with a melting temperature preferably at or above 400° C., phosphate or sulfate glasses melamine poly zinc sulfate, ferro glasses or calcium borosilicate. The addition of such an ash crust stabilizer contributes to a significant stabilization of the ash crust in the event of fire, as these additives increase the mechanical strength of the intumescent layer and/or prevent their dripping. Examples of such additives can be found in U.S. Pat. No. 4,442,157 A, U.S. Pat. No. 3,562,197 A, GB 755 551 A and EP 138 546 A1.

In addition, an ash crust stabilizer, such as melamine phosphate or melamine borate may be included.

Optionally, one or more reactive flame retardants may be added to the composition according to the invention. Such compounds are incorporated in the binder. An example according to the invention are reactive organophosphorus compounds such as 9,10-dihydro-9-oxa-10-phosphaphenanthrene-10-oxide (DOPO) and its derivatives, such as DOPO-HQ, DOPO-NQ, and adducts. Such compounds are described for example by S. V. Levchik, E. D. Weil, Polym. Int 2004, 53, 1901-1929.

The intumescent additive may be contained in an amount of 30 to 99 wt.-% in the composition, whereby the amount is substantially dependent on the type of application of the composition (spraying, brushing and the like). The proportion of the component C is set as high as possible in the total formulation in order to achieve the highest possible intumescent rate. Preferably, the proportion of component C in the total formulation is 35 to 85 wt.-%, and particularly preferably 40 to 85 wt.-%.

In one embodiment, the composition according to the invention further comprises at least one other ingredient selected from among plasticizers, crosslinking agents, water scavengers, organic and/or inorganic aggregates and/or other additives.

The plasticizer has the task of making the cured polymer network soft. Further, the plasticizer has the function of introducing an additional liquid component, so that the fillers are completely wetted and the viscosity is adjusted so that the coating is capable of processing. The plasticizer may be included in such an amount in the composition that it can sufficiently fulfill the above-described functions.

Suitable plasticizers include derivatives of benzoic acid, phthalic acid, for example, phthalates, such as dibutyl, dioctyl, dicyclohexyl, diisooctyl, diisodecyl-, dibenzyl- or butyl benzyl phthalate, trimellitic acid, pyromellitic acid, adipic acid, sebacic acid, fumaric acid, maleic acid, itaconic acid, caprylic acid and citric acid, alkyl phosphate esters and derivatives of polyesters and polyethers, epoxidized oils, C₁₀-C₂₁-alkyl sulfonic acid esters of phenol and alkyl esters. Preferably, the plasticizer is an ester derivative of terephthalic acid, a triol ester of caprylic acid, a glycol diester, diol esters of aliphatic dicarboxylic acids, an ester derivative of citric acid, secondary alkyl sulfonic acid esters, esters of glycerol derivatives having epoxy groups and ester derivatives of phosphates. Most preferably, the plasticizer is bis(2-ethylhexyl)terephthalate, trihydoxy methyl propyl acrylate, triethylene glycol-bis(2-ethylhexanoate), 1,2-cyclohexanedicarboxylic acid-diisononyl ester, a mixture of 75-85% of secondary sulfonic alkane, 15-25% of secondary and alkane disulfonic acid diphenyl ester, 2-3% of non-sulfonated alkanes, triethyl citrate, epoxidized soybean oil, tri-2-ethylhexyl phosphate or a mixture of n-octyl and n-decylsuccinate.

Commercially available examples of plasticizers are EASTMAN® DOTP Plasticizer (Eastman Chemical Company), Esterex® NP 343 (Excon Mobil Corporation), Solusolv® 2075 (Solutia Inc.), Hexamoll® DINCH (BASF SE), Mesamoll® 11 (Lanxess Germany GmbH), triethylcitrate (Sigma Aldrich), Paraplex® G-60 (Hallstar Company), Disflammol® TOF (Lanxess Germany GmbH) and TP LXS Uniplex® ODS (Lanxess Germany GmbH).

In the composition, the plasticizer may be included preferably in an amount of 0.1 to 40 wt.-%, more preferably 1 to 35 wt.-%, and even most preferably 5 to 25 wt. %, with respect to the total composition.

Further, the composition may contain at least one catalyst or a further crosslinking agent, whereby this, if present, is designed to inhibit reaction separately from the component B. The crosslinking agent enables various properties, such as adhesion to the substrate, better wetting of the additives and curing the composition to be optimized and customized.

Suitable catalysts are selected from pure tin-containing compounds. Suitable further crosslinking agents are selected from a reactive alkoxysilane or an oligomeric organofunctional alkoxysilane. Preferably, the catalyst is a tin-containing tin-containing compound. Preferably, the additional crosslinking agent is an oligomeric vinyl-functional alkoxysilane, an oligomeric amino-functional/alkyl-functional alkoxysilane, an oligomeric amino-functional alkoxysilane, an amino-functional alkoxysilane, a alkyl-functional alkoxysilane, an epoxy-functional alkoxysilane, a vinyl-functional alkoxysilane, a vinyl-functional/alkyl-functional alkoxysilane, a mercapto alkoxysilane, a methacryl-functional alkoxysilane or silicic acid esters.

Suitable catalysts or other cross-linking agents are, for example: dibutyltin dilaurate (DBTL), dioctyltin (DOTL), which due to its less toxic properties is preferred over the DBTL, hexadecyltrimethoxysilane, iso-butyltriethoxysilane, iso-butyltri methoxysilane, methyltriethoxysilane, methyltrimethoxysilane, octyltrichlorosilane, octyltriethoxysilane, propyltriethoxysilane, propyltrimethoxysilane, bis(3-triethoxysilylpropyl)amine, bis(3-trimethoxysilylpropyl)amine, 3-aminopropylmethyldiethoxysilane, 3-aminopropyltriethoxysilane, 3-aminopropyltrimethoxysilane, 2-aminoethyl-3-amino-propylmethyldimethoxysilane, 2-aminoethyl-3-amino-propyltri methoxysilane, 3-glycidyloxypropyltriethoxysilane, 3-glycidyloxypropyltri methoxysilane, 3-mercaptoprobyltri methoxysilane, 3-methacryloxypropyltrimethoxysilane, methacryloxymethyl-methyldimethoxysilane, methacryloxymethyl-timethoxysilane, 3-methacryloxypropyltriacetoxysilane, ethylpolysilicate, tetraethyl orthosilicate, tetramethyl orthosilicate, tetra-n-propyl orthosilicate, vinyltrichlorosilane, vinyltriethoxysilane, vinyltrimethoxysilane, vinyltriacetoxysilane, vinyltris(2-methoxyethoxy)silane, N-cyclohexylaminomethyltriethoxysilane, cyclohexyl-3-aminopropyltrimethoxysilane, N-(2-aminoethyl)-3-aminopropyltrimethoxysilane, 3-(2-aminomethylamino) propyltriethoxysilane, N-(2-aminoethyl)-3-amino-prolymethyldimethoxysilane, 3-ureidopropyltrimethoxysilane, N-methyl[3-(trimethoxysilyl)propyl]carbamate, N-trimethoxysilyl methyl-O-methyl carbamate, N-di methoxy(methyl)silyl-methyl-O-methyl carbamate, tris-[3(trimethoxysilyl) propyl]isocyanurate or combinations of these.

Commercially available examples of this include: Dynasylan® 1146, Dynasylan® 6490, Dynasylan® 6498, Dynasylan® SIVO 210, Dynasylan® SIVO 214, Dynasylan® 9116, Dynasylan® IBTEO, Dynasylan® IBTMO, Dynasylan® MTES, Dynasylan® MTMS, Dynasylan® OCTCS, Dynasylan® OCTEO, Dynasylan® OCTMO, Dynasylan® PTEO, Dynasylan® PTMO, Dynasylan® 1122 Dynasylan® 1124, Dynasylan® 1133, Dynasylan® 1204, Dynasylan® 1505, Dynasylan® 1506, Dynasylan® AMEO, Dynasylan® AMEO-T, Dynasylan® AMMO, Dynasylan® 1411, Dynasylan® DAMO, Dynasylan® DAMO-T, Dynasylan® GLYEO, Dynasylan® GLYMO, Dynasylan® MTMO, Dynasylan® MEMO, Dynasylan® 40, Dynasylan® A, Dynasylan® M, Dynasylan® P, Dynasylan® VTC, Dynasylan® VTEO, Dynasylan® VTMO, Dynasylan® VTMOEO, Dynasylan® 6598 (respectively from Evonik Industries AG), Geniosil® GF9, Geniosil® GF 91, Geniosil® GF 92, Geniosil® XL 926, Geniosil® GF 93, Geniosil® GF 94, Geniosil® GF 95, GF 96 Geniosil®, Geniosil® GF 98, Geniosil® XL 10, Geniosil® XL 12, Geniosil® GF 56, Geniosil® GF 62, Geniosil® GF 31, Geniosil® XL 32, Geniosil® XL 33, Geniosil® GF 39, Geniosil® GF 60, Geniosil® XL 63, Geniosil® XL 65, Geniosil® GF 69, Geniosil® GF 80 and Geniosil® GF 82 (respectively from Wacker Chemie AG).

The additional crosslinking agent may contain, individually or as a mixture of several agents, with respect to the binder, preferably an amount of 0.1 to 10 wt.-%, more preferably of 0.5-7 wt.-%, and most preferably from 1-5 wt.-%.

A water scavenger is usually added to the composition to prevent premature reaction of the alkoxysilane with the polymer due to residual moisture which may be present in the composition components, in particular in the fillers and/or additives, or the humidity. The moisture in the formulations is trapped. Preferably, the water scavenger is an organofunctional alkoxysilane or an oligomeric organofunctional alkoxysilane, more preferably a vinyl-functional alkoxysilane, an oligomeric vinyl-functional alkoxysilane, a vinyl-functional/alkyl-functional alkoxysilane, an oligomeric amino-functional/alkyl-functional alkoxysilane, an acetoxy-functional/alkyl-functional alkoxysilane, an amino-functional alkoxysilane, an oligomeric amine functional alkoxysilane, a carbamatosilane or methacryloxy-functional alkoxysilane. Most preferably, the water scavenger is di-tert-butoxydiacetoxysilane, bis(3-triethoxysilylpropyl)amine, bis(3trimethoxypropyl)amine, 3-aminopropyl methyldiethoxysilane, 3-aminopropyl triethoxysilane, vinyl-triethoxysilane, vinyl-trimethoxysilane, vinyl-tris(2-methoxyethoxy)silane, N-cyclohexylaminomethyltriethoxysilane, vinyl-dimethoxymethylsilane, vinyltriacetoxysilane, 3-methacryloxypropyl trimethoxysilane, methacryloxymethyl-methylditrimethoxysilane, methacryloxymethyltrimethoxysilane, 3-methacryloxypropyltriacetoxysilane, N-meth[3-(trimethoxysilyl)propyl]carbamate, N-tri-O-methyl carbamate methoxysilylmethyl, N-dimethoxy(methyl)silyl methyl-O-methylcarbamate, or combinations thereof.

Commercially available examples of this include: Dynasylan® 1146, Dynasylan® 6490, Dynasylan® 6498, Dynasylan® BDAC, Dynasylan® 1122, Dynasylan® 1124, Dynasylan® 1133, Dynasylan® 1204, Dynasylan® 1505, Dynasylan® 1506, Dynasylan® AMEO, Dynasylan® AMEO-T, Dynasylan® VTEO, Dynasylan® VTMO, Dynasylan® VTMOEO, Dynasylan® 6598, (respectively from Evonik Industries AG), Geniosil® XL 926, Geniosil® XL 10, Geniosil® XL 12, Geniosil® GF 56, Geniosil® GF 62, Geniosil® GF 31, Geniosil® XL 32, Geniosil® XL 33, Geniosil® GF 39 Geniosil®, GF 60, Geniosil® XL 63 and Geniosil® XL 65 (respectively from Wacker Chemie AG).

The added amount of water scavenger depends on the water content of the components of the formulation, excluding the extra added water (component B) and is usually in the range of about 1 wt. %. With respect to the total composition, the water scavenger can be used in an amount of 0.1 to 2 wt.-%, preferably from 0.2 to 2 wt.-%, more preferably from 0.2 to 1.8 wt.-% and even more preferably 0.25 to 1.5 wt.-%.

The composition may also contain, in addition to the additives already described and if appropriate, customary auxiliary agents such as wetting agents, for example those based on polyacrylates and/or polyphosphates, defoamers, such as silicone defoamers, dyes, fungicides, and various fillers, such as vermiculite, inorganic fibers, silica sand, glass microspheres, mica, silica, mineral wool, and the like.

Additional additives, such as thickeners and/or rheology additives and fillers may be added to the composition. Rheological additives that may be used include anti-settling, anti-sag and thixotropic agents, preferably polyhydroxycarbonic acid amides, urea derivatives, salts of unsaturated carboxylic esters, alkyl ammonium salts of acidic phosphoric acid derivatives, ketoximes, amine salts of p-toluenessulfonic acid, amine salts of sulfonic acid derivatives and aqueous or organic solutions or mixtures of the compounds. In addition, rheology additives may be used on the basis of pyrogenic or precipitated silicas or silanized pyrogenic or precipitated silicas. It is preferable that the rheology additives are pyrogenic silicas, modified and unmodified sheet silicates, precipitated silicas, cellulose ethers, polysaccharides, polyurethane and acrylic thickeners, urea derivatives, castor oil derivatives, polyamides and fatty acid amides and polyolefins, insofar as they are in solid form, powdered cellulose and/or suspending agents, such as xanthan gum.

The composition according to the invention is formulated as a two or multi-component system. Preferably it is packaged as a two-component system, in which the component A and the component B are divided into two components, component I and component II in order to inhibit reaction.

The further components of the composition are divided according to their compatibility with each other and with the compounds contained in the composition and may be present in one of the two components or in both components. If added, the water scavenger and cross-linking agent should be formulated separately from the components contained in component B.

Further, the division of the other components, in particular the solid components, depend on what amounts are to be included in the composition. By appropriate allocation, a higher proportion may possibly arise with respect to the total composition.

It is also possible, that a component only contains the component B. Alternatively, the component B may, together with other components such as plasticizers, additives, and/or fillers, may be included in one component of the two-component system.

The component C may be included as a total mixture or as individual components in a component or multiple components. The distribution of the component C is carried out as a function of the compatibility of the compounds contained in the composition, so that neither a reaction of the compounds contained in the composition can take place with one another, nor mutual reaction of these compounds with the compounds of the other components. This is dependent on the compounds used.

Preferably, component C, comprising at least one carbon source, at least one blowing agent and at least one dehydrogenation catalyst, is divided in such a way in component I and component II, that these compounds (the individual components of the intumescent component) and the other components, i.e. components (A) and (B) are separated in order to inhibit reaction of the composition. This ensures that the highest possible proportion of fillers can be achieved. This leads to a high intumescence, even in the case of low coating thicknesses of the composition.

If the intumescent additive contains an ash crust stabilizer, then this may be included in either component I or in component II. Alternatively, the ash crust stabilizer may also be divided between the two components I and II. Accordingly, the ash crust stabilizer is so divided between component I and component II that component I or component II contains at least a portion of the ash crust stabilizer while component I or component II optionally contains a further part of the ash crust stabilizer.

The composition is applied as a paste with a brush, a roller or by spraying onto the substrate, in particular a metallic substrate. Preferably, the composition is applied by means of an airless spray method.

When compared with the solvent and water-based systems and the system according to WO 2010/131037 A1, the composition according the invention is characterized by relatively rapid curing through hydrolysis and an associated polycondensation reaction, and thus physical drying out is unnecessary. Moreover, the curing properties and the properties of the dried (cured) composition can be controlled via the water content in the composition. This is particularly important when the coated components must be loaded or processed quickly, either by coating with a topcoat or when moving or transporting the components. The coating is thus significantly less susceptible to external influences at the site, such as being hit by (rain) water or dust and dirt, which can lead, in the case of solvent or water-based systems, to the leaching of water-soluble ingredients, such as ammonium polyphosphate, or to a reduced intumescence on collecting dust. Due to the low fusion point of the binder and the high solids content, the rate of expansion itself is high when exposed to heat even in the case of low layer thickness.

Therefore, the two or multi-component coating composition according to the invention is suitable in particular as a flame-retardant coating, preferably in the form of a sprayable coating for metallic and non-metallic substrates. The substrates are not limited and include components, especially steel components and wooden components, as well as individual cables, cable bundles, cable trays and cable ducts or other cabling.

The composition according to the invention is used mainly in the construction industry as a coating, in particular as a fire protection coating for steel construction elements, but also for construction elements made from other materials, such as concrete or wood, as well as a fire protection coating for single cable, cable bundles, cable trays and cable ducts or other cabling.

A further object of the invention is, therefore, the use of the composition according to the invention as a coating, particularly as a coating for structural elements or components of steel, concrete, wood and other materials, such as plastics, especially as a fire protection coating.

The present invention also relates to objects that are protected when the composition according to the invention is cured. The objects have excellent intumescent properties.

The following examples serve to illustrate the invention.

### Exemplary Embodiments

The ingredients listed below are used for the production of intumescent compositions according to the invention. The individual components are respectively mixed by means of a dissolver and homogenized. These mixtures are then mixed either before spraying or preferably during spraying and applied.

The curing of the composition is monitored and the intumescent factor and relative ash crust stability then determined. For this purpose, the compositions are each placed in a circular Teflon mold of about 2 mm depth and 48 mm diameter. The samples are cured at a temperature of +22° C. and a relative humidity of 35%.

Wedge-shaped samples (1-10 mm) are molded for the determination of the curing time. The curing time corresponds to the time taken for the layer thickness h_{A} to be cured.

A muffle furnace is preheated to 600° C. in order to determine the intumescent factor and the relative stability of the ash crust. Multiple measurements of the sample thickness are carried out using callipers and the mean h_{M} determined. Then, the samples are each placed in a cylindrical steel mold and heated for 30 min in a muffle furnace. After cooling to room temperature, the foam height H_{E1} is first destructively determined (mean value of the multiple measurements). The intumescent factor I is calculated as follows:

Intumescent factor I: I=h_{E1}:h_{M}

Then a defined weight (m=105 g) is allowed to fall from a defined height (h=100 mm) onto the foam in the cylindrical steel mold in order to determine the foam height H_{E2} remaining, following this partially destructive action. The relative ash crust stability is calculated as follows:

relative ash crust stability (ACS): ACS=h_{E2}: h_{E1}

The following composition was prepared as the component C and the mixture was used in the amount indicated in each case for the comparative example and the following examples 1-3:

Component C:

| Compounds | Quantity [g] |
|---|---|
| Pentaerythritol | 8.7 |
| Melamine | 8.7 |
| Ammonium polyphosphate | 16.6 |
| Titanium dioxide | 7.9 |

### Comparative Example 1

### Component A

| Compounds | Quantity [g] |
|---|---|
| Dimethoxy(methyl)silylmethylcarbamat- | 11.0 |
| terminated polyether¹ | |
| Vinyldimethoxymethylsilane² | 0.5 |
| Di-(2-ethylhexyl)adipate³ | 2.2 |
| 3-aminopropyltriethoxysilane⁴ | 0.3 |

¹GENIOSIL ® STP-E 10 (methoxy content approximately 0.4-0.5 mmol/g)
²GENIOSIL ® XL 12 (water scavenger)
³Plastomoll ® DOA (plasticizer)
⁴Dynasylan ® AMEO (crosslinking agent)

### Component C

| Compounds | Quantity [g] |
|---|---|
| as indicated above | 21.0 |

### Comparative Example 2

An aqueous dispersion technology based on a commercial fire protection product (Hilti CFP S-WB) is used for comparison.

### Comparative Example 3

A standard epoxy-amine system (Jeffamin® T-403, liquid, solvent-free and crystallization-stable epoxy resin, consisting of low molecular epoxy resins based on bisphenol A and bisphenol F (Epilox® AF 18-30, Leuna-Harze GmbH) and 1,6-hexanediol diglycidyl ether), which is filled to 60% with an intumescent mixture is tested analogously to the above examples as a further comparison.

### Comparative Example 4

A standard epoxy-amine system (isophoronediamine, trimethylolpropane and liquid, solvent-free and crystallization-stable epoxy resin consisting of low molecular weight epoxy resins based on bisphenol A and bisphenol F (Epilox® AF 18-30, Leuna-Harze GmbH)), which is filled to 60% with an intumescent mixture is tested analogously to the above examples as a further comparison.

### Example 1

### Component A

| Compounds | Quantity [g] |
|---|---|
| GENIOSIL ® STP-E 10 | 10.96 |
| GENIOSIL ® XL 12 | 0.47 |
| Plastomoll ® DOA | 2.21 |
| Dynasylan ® AMEO | 0.32 |

### Component B

| Compounds | Quantity [g] |
|---|---|
| Water | 0.06 |

### Component C

| Compounds | Quantity [g] |
|---|---|
| as indicated above | 21.0 |

### Example 2

### Component A

| Compounds | Quantity [g] |
|---|---|
| GENIOSIL ® STP-E 10 | 10.88 |
| GENIOSIL ® XL 12 | 0.48 |
| Plastomoll ® DOA | 2.22 |
| Dynasylan ® AMEO | 0.32 |

### Component B

| Compounds | Quantity [g] |
|---|---|
| Water | 0.19 |

### Component C

| Compounds | Quantity [g] |
|---|---|
| as indicated above | 21.0 |

### Example 3

### Component A

| Compounds | Quantity [g] |
|---|---|
| GENIOSIL ® STP-E 10 | 10.78 |
| GENIOSIL ® XL 12 | 0.48 |
| Plastomoll ® DOA | 2.20 |
| Dynasylan ® AMEO | 0.32 |

### Component B

| Compounds | Quantity [g] |
|---|---|
| Water | 0.32 |

### Component C

| Compounds | Quantity [g] |
|---|---|
| as indicated above | 21.0 |

### Example 4

### Component A

| Compounds | Quantity [g] |
|---|---|
| GENIOSIL ® STP-E 10 | 9.42 |
| GENIOSIL ® XL 12 | 0.41 |
| Plastomoll ® DOA | 3.77 |
| Dynasylan ®AMEO | 0.27 |

### Component B

| Compounds | Quantity [g] |
|---|---|
| Water | 0.14 |

### Component C

| Compounds | Quantity [g] |
|---|---|
| as indicated above | 21.0 |

On the one hand, the results shown in Table 1 clearly show that the curing of the compositions according to the invention is much faster than the comparative composition. Already with a water content of 0.5 wt.-% based on the polymer, a composition according to the invention cures about five times faster than the comparative composition of

comparable thickness. At a water content of 1.5%, the curing can be reduced by a factor of 8.5.

TABLE 1
Results of the measurements of the curing time

| | Sample thickness h_{A} | | |
|---|---|---|---|
| Sample | (mm) | Curing time | |
| 1 | 7 | 3 | hours |
| 2 | 10 | 2 | hours |
| 3 | 10 | 2 | hours |
| 4 | 10 | 2 | hours |
| Comparative example 1 | 6 | 17 | hours |
| Comparative example 2 | 2 | 10 | days |
| Comparative example 3 | 10 | 12 | hours |
| Comparative example 4 | 10 | 1 | day |

¹⁾ not measured

TABLE 2
Results of measurements of the intumescent factor and the ash
crust stability

| | Intumescent | Relative ash crust | Sample |
|---|---|---|---|
| | factor I | stability ACS | thickness h_{M} |
| Sample | (multiple) | (multiple) | (mm) |
| 1 | 18.7 | 0.25 | 1.1 |
| 2 | 19.5 | 0.32 | 1.3 |
| 3 | 15.3 | 0.30 | 1.5 |
| 4 | 20.0 | 0.26 | 1.2 |
| Comparative example 3 | 22 | 0.04 | 1.6 |
| Comparative example 4 | 1.7 | 0.60 | 1.2 |

¹⁾ not measured

1-15. (canceled)

16. Intumescence-forming composition with a component A containing an alkoxysilane polymer, which is terminated and/or as side groups along the polymer chain alkoxy silane groups of the general formula (I)
—Si(R¹)ₘ(OR²)₃₋ₘ (I),
whereby R¹ is a linear or branched C₁-C₁₆ alkyl radical, R² is a linear or branched C₁-C₆ alkyl radical and m is an integer from 0 to 2, with a component B containing the water, and with a component C containing an insulation-forming additive.

17. Composition according to claim 16, whereby the component A and the component B are separated to inhibit reaction.

18. Composition according to claim 16, whereby the polymer comprises a network selected from the group consisting of a polyether, polyester, polyetherester, polyamide, polyurethane, polyester urethane, polyether urethane, polyetheresterurethane, polyamideurethane, polyurea, polyamine, polycarbonate, polyvinyl polyacrylate, polyolefin, polyisobutylene, polysulfide, rubber, neoprene, phenol resin, epoxy resin and melamine.

19. Composition according to claim 16, whereby the alkoxysilane carries at least two polymer alkoxy silane groups.

20. Composition according to claim 19, whereby the alkoxysilane carries polymer 2 to 8 alkoxy-functional silane groups.

21. Composition according to claim 19, whereby the content of alkoxy groups of the polymer is from 0.20 to 0.85 mmol/g.

22. Composition according to claim 16, whereby the content is based on water in the composition up to 3 wt.-% with respect to the polymer.

23. Composition according to claim 16, whereby the intumescent additive is a mixture, optionally comprising at least one carbon source, at least one dehydrogenation catalyst and at least one blowing agent, and/or comprises at least one thermo-expandable compound.

24. Composition of claim 23, whereby the intumescent additive further comprises an ash crust stabilizer.

25. Composition according to claim 16, whereby the composition further contains at least one further ingredient selected from among plasticizers, crosslinking agents, water scavengers, inorganic fillers and/or other additives.

26. Composition according to claim 16, whereby the composition is formulated as a two or multi-component system.

27. Composition according to claim 26, whereby the composition is formulated as two-component system and component A and component B are divided into two components, component I and component 11, in order to inhibit reaction.

28. Composition according to claim 27, whereby component C comprises at least one carbon source, at least one blowing agent and at least one dehydrogenation catalyst and these compounds are divided in such a way between component I and component II that they are separated from the other components of the composition in order to inhibit reaction.

29. Use of the composition as a coating according to claim 16.

30. Use for the coating of steel construction elements according to claim 29.

31. Use for the coating of non-metallic components according to claim 29.

32. Use as a fire protection layer according to claim 29.

33. Cured objects obtained by curing the composition according to claim 16.
